(19) United States
(12) Patent Application Publication
(10) Pub. No.: US 2026/0302502 A1
(43) Pub. Date: Oct. 1, 2026

(54) BATTERY MODULE

(71) Applicant: HONDA MOTOR CO., LTD., Tokyo (JP)

(72) Inventor: Hidemasa USUI, Saitama (JP)

(21) Appl. No.: 19/629,691

(22) Filed: Mar. 26, 2026

(30) Foreign Application Priority Data
Mar. 31, 2025 (JP) 2025-060080

(51) Int. Cl. H01M 50/293; H01M 4/40; H01M 50/242; H01M 50/291; H01M 4/02

(52) U.S. Cl. CPC H01M 50/293; H01M 4/405; H01M 50/242; H01M 50/291; H01M 2004/027

(57) ABSTRACT

Provided is a battery module including: a battery cell stack including a plurality of battery cells that are stacked together; and an elastic member arranged between the plurality of battery cells. The elastic member includes a first elastic member, and a second elastic member arranged on each of opposite sides of the first elastic member in a stacking direction of the battery cells. The second elastic member is an elastic foam. When a surface pressure of greater than or equal to 1 MPa and less than or equal to 2.5 MPa is applied to the elastic foam and the surface pressure [MPa] is plotted with respect to compression strain [%], a slope [MPa/%] of the surface pressure with respect to the compression strain is greater than or equal to 0.030 and less than or equal to 0.231.

### BACKGROUND OF THE INVENTION

This application is based on and claims the benefit of priority from Japanese Patent Application No. 2025-060080, filed on 31 Mar. 2025, the content of which is incorporated herein by reference.

### Field of the Invention

The present invention relates to a battery module.

### Related Art

In recent years, research and development concerning battery modules that contribute to energy efficiency has been conducted to enable more people to access affordable, reliable, sustainable, and advanced energy.

Japanese Unexamined Patent Application, Publication No. 2003-303579 discloses a module containing a flat secondary battery. In this case, the module is formed by arranging a fluid-containing bag in which a fluid is contained and made airtight, between a module exterior body that pressurizes and fixes the flat secondary battery and the flat secondary battery.

### Patent Document 1: Japanese Unexamined Patent Application, Publication No. 2003-303579

### SUMMARY OF THE INVENTION

However, in the case where the fluid-containing bag disclosed in Japanese Unexamined Patent Application, Publication No. 2003-303579 is arranged between a plurality of battery cells, air enters between the fluid-containing bag and the battery cells, and uniformity of surface pressure is likely to decrease.

An object of the present invention is to provide a battery module capable of increasing uniformity of surface pressure of an elastic member.
(1) A battery module including: a battery cell stack including a plurality of battery cells that are stacked together; and an elastic member arranged between the plurality of battery cells. The elastic member includes a first elastic member, and a second elastic member arranged on each of opposite sides of the first elastic member in a stacking direction of the battery cells. The second elastic member is an elastic foam. When a surface pressure of greater than or equal to 1 MPa and less than or equal to 2.5 MPa is applied to the elastic foam and the surface pressure [MPa] is plotted with respect to compression strain [%], a slope [MPa/%] of the surface pressure with respect to the compression strain is greater than or equal to 0.030 and less than or equal to 0.231.
(2) In the battery module according to (1), compression strain when a surface pressure of 1 MPa is applied to the elastic foam is greater than or equal to 30.0% and less than or equal to 92.0%.
(3) In the battery module according to (1) or (2), compression strain when a surface pressure of 2.5 MPa is applied to the elastic foam is greater than or equal to 60.0% and less than or equal to 98.5%.
(4) In the battery module according to any one of (1) to (3), the elastic foam is an open-cell foam.
(5) In the battery module according to any one of (1) to (4), the elastic member has a thickness of less than or equal to 3 mm.
(6) In the battery module according to any one of (1) to (5), the first elastic member is a pouch in which a gas is enclosed.
(7) In the battery module according to (6), the pouch includes a sealer extending in a direction perpendicular to the stacking direction of the battery cells, and the sealer is in contact with the elastic foam.
(8) In the battery module according to (6) or (7), the pouch has an inner pressure of greater than or equal to 0.1 MPa and less than or equal to 3.0 MPa.
(9) In the battery module according to any one of (1) to (8), the battery cells include a cell including a negative electrode mixture layer containing lithium metal or a lithium alloy.
(10) In the battery module according to any one of (1) to (9), the battery cells include a solid-state battery cell.

According to the present invention, it is possible to provide a battery module capable of increasing uniformity of surface pressure of an elastic member.

### BRIEF DESCRIPTION OF THE DRAWINGS

FIG. 1 is a side elevational view showing a battery module according to one embodiment of the present invention;

FIG. 2A is a partially enlarged perspective view of the battery module in FIG. 1;

FIG. 2B is a schematic view showing a cross section along line A-A in FIG. 2A;

FIG. 2C is a schematic view showing a cross section along line B-B in FIG. 2A; and

FIG. 3 is a schematic view showing a cross section of a modification example of the battery module in FIG. 2B.

### DETAILED DESCRIPTION OF THE INVENTION

Hereinafter, an embodiment of the present invention will be described with reference to drawings.

### Battery Module

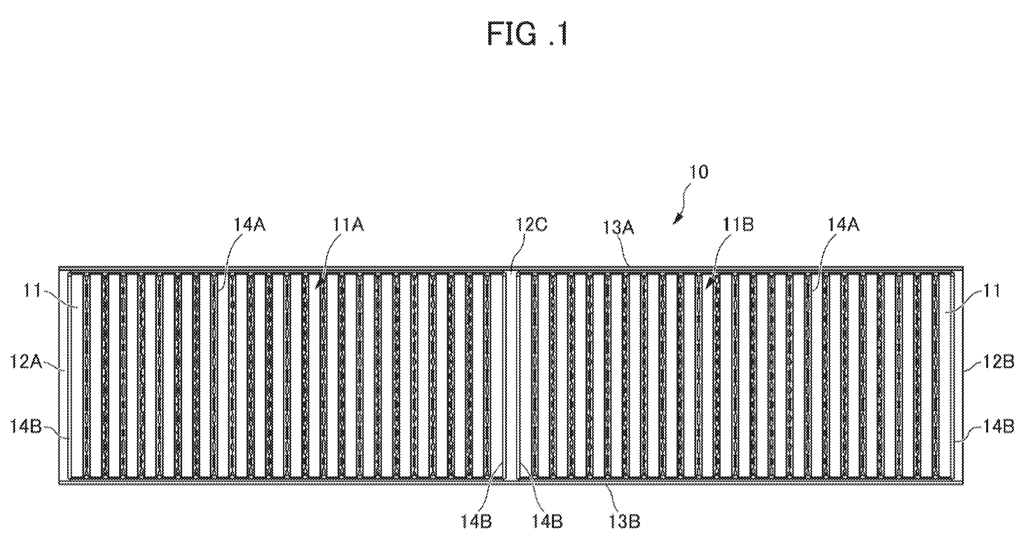

FIG. 1 shows a battery module according to one embodiment of the present invention.

A battery module 10 includes battery cell stacks 11A and 11B in each of which a plurality of battery cells 11 are stacked, end plates 12A and 12B provided on opposite end parts of the battery cell stacks 11A and 11B in a stacking direction, and a center plate 12C provided between the battery cell stacks 11A and 11B. The battery module 10 further includes bind bars 13A and 13B that bind the battery cell stacks 11A and 11B between the end plates 12A and 12B. Binding pressure due to the bind bars 13A and 13B is, for example, greater than or equal to 1.0 MPa and less than or equal to 2.5 MPa, although this is not particularly limitative.

In the battery module 10, an elastic member 14A is arranged between the plurality of battery cells 11, and elastic members 14B are arranged between the battery cell stack 11A and each of the end plate 12A and the center plate 12C and between the battery cell 11 and each of the end plate 12B and the center plate 12C, respectively. In this case, since the elastic member 14B is in contact with a single battery cell 11, the elastic member 14B is not particularly limited as long as the elastic member 14B has elasticity greater than or equal to approximately half that of the elastic member 14A in contact with two battery cells 11. The elastic member 14B preferably has a structure similar to that of the elastic member 14A except that a thickness of the elastic member 14B is approximately half that of the elastic member 14A in terms of energy density of the battery module 10, but the elastic member 14B may be the same as the elastic member 14A.

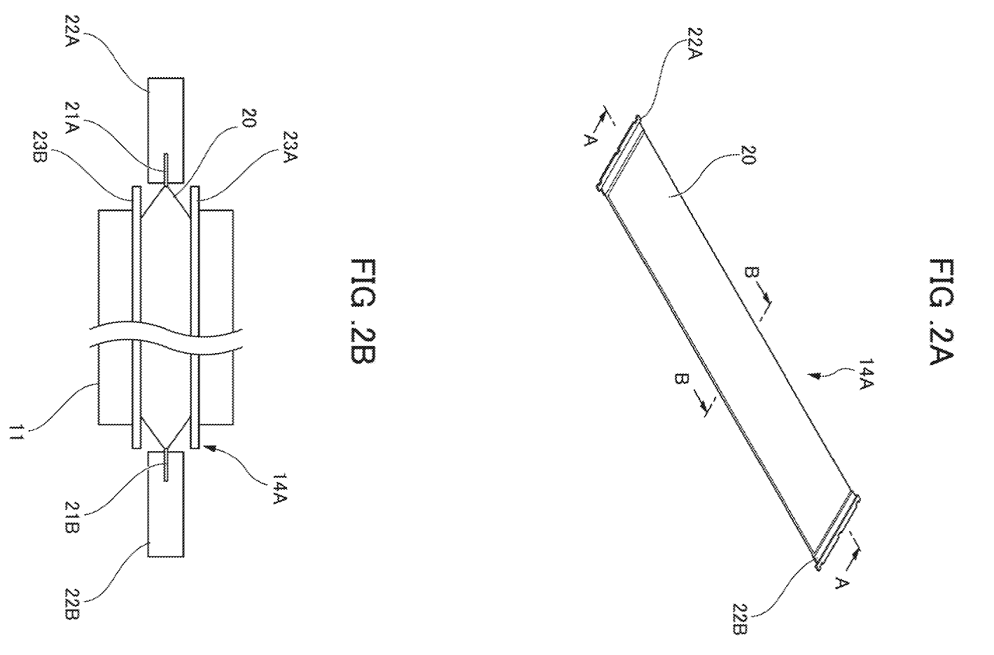

The elastic member 14A includes, as shown in FIGS. 2A, 2B, and 2C, a pouch 20 as a first elastic member in which a gas is enclosed, and elastic foams 23A and 23B as second elastic members arranged on opposite sides of the pouch 20 in the stacking direction of the battery cell 11. In this case, when the elastic member 14A is compressed due to expansion of the battery cell 11 during charging, the elastic foams 23A and 23B are present between the battery cell 11 and the pouch 20, and therefore, uniformity of surface pressure of the elastic member 14A increases. Note that the battery cell 11 and the elastic foams 23A and 23B are not shown in FIG. 2A.

When a surface pressure of greater than or equal to 1.0 MPa and less than or equal to 2.5 MPa is applied to each of the elastic foams 23A and 23B and the surface pressure [MPa] is plotted with respect to compression strain [%], a slope [MPa/%] of the surface pressure with respect to the compression strain is greater than or equal to 0.030 and less than or equal to 0.231, preferably greater than or equal to 0.037 and less than or equal to 0.067. Since the slope [MPa/%] of the surface pressure with respect to the compression strain is greater than or equal to 0.030 and less than or equal to 0.231, the uniformity of the surface pressure of the elastic member 14A increases.

Note that the compression strain of the elastic foams 23A and 23B is measured in conformity with JIS K 6262.

The compression strain when a surface pressure of 1.0 MPa is applied to each of the elastic foams 23A and 23B is preferably greater than or equal to 30.0% and less than or equal to 92.0%, and more preferably greater than or equal to 30.0% and less than or equal to 76.0%. In the case where the compression strain is greater than or equal to 30.0% and less than or equal to 92.0% when a surface pressure of 1.0 MPa is applied to each of the elastic foams 23A and 23B, the uniformity of the surface pressure of the elastic member 14A increases.

The compression strain when a surface pressure of 2.5 MPa is applied to each of the elastic foams 23A and 23B is preferably greater than or equal to 60.0% and less than or equal to 98.5%, and more preferably greater than or equal to 71.0% and less than or equal to 98.5%. In the case where the compression strain is greater than or equal to 60.0% and less than or equal to 98.5% when a surface pressure of less than or equal to 2.5 MPa is applied to each of the elastic foams 23A and 23B, the uniformity of the surface pressure of the elastic member 14A increases.

The elastic foams 23A and 23B are preferably open-cell foams. Thus, the uniformity of the surface pressure of the elastic member 14A increases.

A porosity of each of the elastic foams 23A and 23B is, for example, greater than or equal to 30% and less than or equal to 95%, although this is not particularly limitative. Examples of a material that constitutes the elastic foams 23A and 23B include polyurethane, silicone resin, ethylene propylene rubber, styrene resin, olefin resin, polyamide, and polyester, although these are not particularly limitative.

A thickness of the elastic member 14A is preferably less than or equal to 6 mm, and more preferably less than or equal to 3 mm. When the thickness of the elastic member 14A is less than or equal to 3 mm, energy density of the battery module 10 increases. Note that the thickness of the elastic member 14A is, for example, greater than or equal to 2.5 mm.

Here, a thickness of the pouch 20 when the binding pressure is 1.0 MPa is, for example, greater than or equal to 1 mm and less than or equal to 5 mm, although this is not particularly limitative. A thickness of each of the elastic foams 23A and 23B when the binding pressure is 1.0 MPa is, for example, greater than or equal to 0.02 mm and less than or equal to 3 mm, although this is not particularly limitative.

Inner pressure of the pouch 20 is preferably greater than or equal to 0.1 MPa and less than or equal to 3.0 MPa, preferably greater than or equal to 1.0 MPa and less than or equal to 2.5 MPa. With the pouch 20 having an inner pressure of greater than or equal to 1.0 MPa, the uniformity of the surface pressure of the elastic member 14A increases. With the pouch 20 having an inner pressure of less than or equal to 2.5 MPa, damage to the pouch 20 is suppressed even when the battery cell 11 is expanded and contracted during charging and discharging of the battery cell 11.

As shown in FIG. 2C, the pouch 20 includes a third sealer 21C that extends in a longitudinal direction (a direction A-A) perpendicular to the stacking direction of the battery cell 11, and the third sealer 21C is in contact with the elastic foam 23B. Thus, the uniformity of the surface pressure of the elastic member 14A increases.

As shown in FIG. 2B, the pouch 20 includes a first sealer 21A and a second sealer 21B in opposite end parts in the longitudinal direction (the direction A-A) perpendicular to the stacking direction of the battery cell 11. In this case, the elastic member 14A further includes a first supporter 22A that supports an approximately entire area of the first sealer 21A, and a second supporter 22B that supports an approximately entire area of the second sealer 21B. The first supporter 22A and the second supporter 22B are positioned by, for example, a positioning member provided in the battery module 10.

The pouch 20 is not particularly limited as long as the pouch 20 can be sealed and has flexibility of being able to follow the expansion and contraction of the battery cell 11 during charging and discharging; for example, an aluminum film is sandwiched between films of flexible resin. Examples of the flexible resin include polypropylene, polyamide, and polyester, although these are not particularly limitative.

A method for forming the first sealer 21A, the second sealer 21B, and the third sealer 21C is, for example, a method of performing thermal fusion bonding on the flexible resin that constitutes the pouch 20, although this is not particularly limitative.

Examples of the pouch 20 include a pillow pouch (commercially available product), although this is not particularly limitative. Examples of the gas that is enclosed in the pouch 20 include air, although this is not particularly limitative.

Note that, instead of the pouch 20, a pouch including the first sealer 21A and the second sealer 21B in the opposite end parts in the longitudinal direction (the direction A-A) perpendicular to the stacking direction of the battery cell 11 and including a sealer other than the third sealer 21C may be used.

A material that constitutes the first supporter 22A and the second supporter 22B is resin or metal, although these are not particularly limitative.

A method for fixing the elastic foam 23A (or 23B) to the pouch 20 is, for example, a method of using an elastic adhesive to achieve adhesion of the elastic foam 23A (or 23B) to the pouch 20, although this is not particularly limitative.

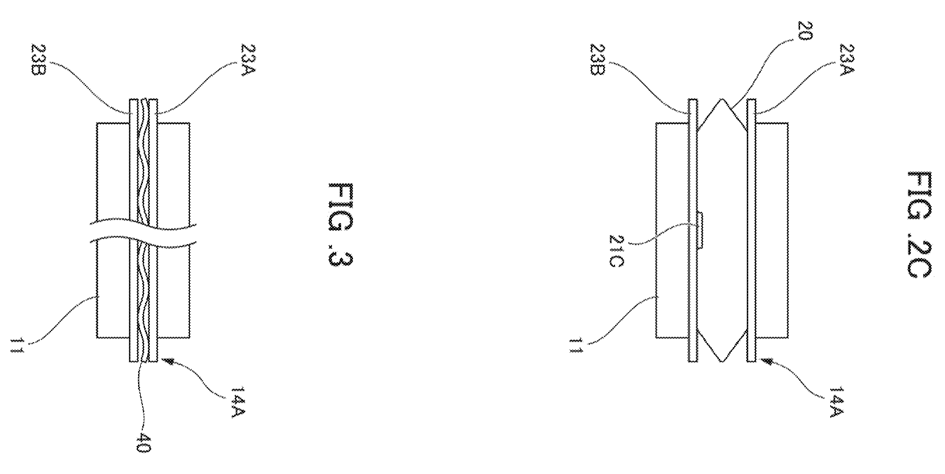

Note that a corrugated sheet spring 40 may be used as the first elastic member (see FIG. 3). Alternatively, a stack of the pouch 20 and the corrugated sheet spring 40 may be used as the first elastic member. The corrugated sheet spring 40 preferably includes fiber reinforced plastic (FRP). This allows thermal resistance and thermal insulation properties of the corrugated sheet spring 40 to be compatible. Example of the FRP include carbon fiber reinforced plastic (CFRP) and glass fiber reinforced plastic (GFRP).

A method for fixing the corrugated sheet spring 40 is, for example, a method of using an elastic adhesive to achieve adhesion of the corrugated sheet spring 40, although this is not particularly limitative. Note that the corrugated sheet spring 40 is manufactured by, for example, press molding.

### Cell

Examples of a cell that constitutes the battery cell 11 include solid-state battery cells such as all-solid-state battery cells and semi-solid-state battery cells, and non-aqueous electrolytic solution battery cells including negative electrode mixture layers containing lithium metal or a lithium alloy, although these are not particularly limitative. Examples of an element that constitutes the lithium alloy except lithium include Sn, Ag, Mg, In, Si, and Al, although these are not particularly limitative. Among these, the solid-state battery cells including negative electrode mixture layers containing lithium metal or a lithium alloy are preferable in terms of energy density.

The following describes an example of the all-solid-state battery cell.

The all-solid-state battery cell includes a negative electrode current collector, a negative electrode mixture layer containing lithium metal or a lithium alloy, a solid electrolyte layer, a positive electrode mixture layer, and a positive electrode current collector.

Examples of a material that constitutes the negative electrode current collector include silver, palladium, gold, platinum, aluminum, copper, nickel, stainless steel, and carbon, although these are not particularly limitative. Among these, copper, stainless steel, and nickel are preferable in terms of conductivity and costs.

Examples of a shape of the negative electrode current collector include foil shapes, sheet shapes, mesh shapes, nonwoven fabric shapes, and foam shapes, although these are not particularly limitative.

Examples of a solid electrolyte that constitutes the solid electrolyte layer include sulfide solid electrolytes and oxide solid electrolytes, although these are not particularly limitative.

Examples of a form of the solid electrolyte include particles, although this is not particularly limitative.

The content of the solid electrolyte contained in the solid electrolyte layer is, for example, greater than or equal to 50% by mass and less than or equal to 99% by mass, although this is not particularly limitative.

The solid electrolyte layer may further include a binder or the like.

A method for forming the solid electrolyte layer is, for example, a method of applying slurry including the solid electrolyte and a solvent, although this is not particularly limitative.

The positive electrode mixture layer includes a positive electrode active material. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), Li₁₊ₓMn_{2-x-y}M_{y}O₄ (x+y=2) (note that M is one or more elements selected from a group consisting of Al, Mg, Co, Fe, Ni, and Zn), lithium titanium oxide, and LiMPO₄ (note that M is one or more elements selected from a group consisting of Fe, Mn, Co, and Ni), although these are not particularly limitative.

The content of the positive electrode active material contained in the positive electrode mixture layer is, for example, greater than or equal to 50% by mass and less than or equal to 99% by mass, although this is not particularly limitative.

The positive electrode mixture layer may further include a solid electrolyte. The solid electrolyte is not particularly limited as long as lithium ions can be conducted, and examples of the solid electrolyte include oxide solid electrolytes and sulfide solid electrolytes.

The positive electrode mixture layer may further include a binder, a conductive additive, or the like.

A method for forming the positive electrode mixture layer is, for example, a method of applying slurry including the positive electrode active material and a solvent, although this is not particularly limitative.

Examples of a material that constitutes the positive electrode current collector include aluminum, an aluminum alloy, stainless steel, nickel, iron, and titanium, although these are not particularly limitative. Among these, aluminum, an aluminum alloy, and stainless steel are preferable.

Examples of a shape of the positive electrode current collector include foil shapes and sheet shapes, although these are not particularly limitative.

Although an embodiment of the present invention is described in the foregoing, the present invention is not limited to the embodiment disclosed and the embodiment may be changed as appropriate within the spirit of the present invention.

### EXPLANATION OF REFERENCE NUMERALS

10 battery module

11 battery cell

11A,11B battery cell stack

12A,12B end plate

12C center plate

13A,13B bind bar

14A,14B elastic member

20 pouch

21A first sealer

21B second sealer

21C third sealer

22A first supporter

22B second supporter

23A,23B elastic foam

40 corrugated sheet spring

What is claimed is:

1. A battery module comprising:
a battery cell stack including a plurality of battery cells that are stacked together; and
an elastic member arranged between the plurality of battery cells,
wherein the elastic member comprises a first elastic member, and a second elastic member arranged on each of opposite sides of the first elastic member in a stacking direction of the battery cells,
wherein the second elastic member is an elastic foam, and
wherein, when a surface pressure of greater than or equal to 1 MPa and less than or equal to 2.5 MPa is applied to the elastic foam and the surface pressure [MPa] is plotted with respect to compression strain [%], a slope [MPa/%] of the surface pressure with respect to the compression strain is greater than or equal to 0.030 and less than or equal to 0.231.

2. The battery module according to claim 1, wherein compression strain when a surface pressure of 1.0 MPa is applied to the elastic foam is greater than or equal to 30.0% and less than or equal to 92.0%.

3. The battery module according to claim 1, wherein compression strain when a surface pressure of 2.5 MPa is applied to the elastic foam is greater than or equal to 60.0% and less than or equal to 98.5%.

4. The battery module according to claim 1, wherein the elastic foam is an open-cell foam.

5. The battery module according to claim 1, wherein the elastic member has a thickness of less than or equal to 3 mm.

6. The battery module according to claim 1, wherein the first elastic member is a pouch in which a gas is enclosed.

7. The battery module according to claim 6,
wherein the pouch comprises a sealer extending in a direction perpendicular to the stacking direction of the battery cells, and
wherein the sealer is in contact with the elastic foam.

8. The battery module according to claim 6, wherein the pouch has an inner pressure of greater than or equal to 0.1 MPa and less than or equal to 3.0 MPa.

9. The battery module according to claim 1, wherein the battery cells comprise a cell including a negative electrode mixture layer containing lithium metal or a lithium alloy.

10. The battery module according to claim 1, wherein the
battery cells comprise a solid-state battery cell.
